(19) United States
(12) Patent Application Publication
(10) Pub. No.: US 2025/0033021 A1
(43) Pub. Date: Jan. 30, 2025

(54) HYDROGEN PRODUCTION SYSTEM AND METHOD

(71) Applicant: CATAGEN LIMITED, Belfast (GB)

(72) Inventors: Andrew Woods, Belfast (GB); Matthew Elliott, Carrickfergus (GB); Robert Douglas, Ballymena (GB)

(21) Appl. No.: 18/696,588

(22) PCT Filed: Sep. 29, 2022
(86) PCT No.: PCT/EP2022/077196

§ 371 Date: Mar. 28, 2024

(30) Foreign Application Priority Data
Sep. 29, 2021 (GB) 2113957.1

(51) Int. Cl. B01J 19/24; B01J 19/00; C01B 3/06

(52) U.S. Cl. CPC B01J 19/2465; B01J 19/0013; C01B 3/068; B01J 2219/00103; B01J 2219/00135; B01J 2219/00243

(57) ABSTRACT

A system for producing hydrogen from water by a thermochemical cycle, for example the sulphuriodine cycle, comprises a reactor having reaction zones for implementing the reactions of the cycle. The reaction zones are interconnected by a fluid circuit and the reactor is configured to direct reaction product(s) from any reaction zone to another reaction zone to provide reactant(s) for the other reaction zone. Fluid is recirculated around the fluid circuit so that reaction product(s) from downstream reaction zone(s) are reused as reactant(s) for upstream reaction zone(s). Heat generated in reaction zone(s) is also reused in other reaction zone(s). The resulting system is energy efficient as well as being efficient in its use of reactants.

### FIELD OF THE INVENTION

This invention relates to systems and methods for hydrogen (H₂) production.

### BACKGROUND TO THE INVENTION

Known methods of hydrogen (H₂) production include steam reforming of natural gas, partial oxidation of methane, coal gasification, biomass gasification, methane pyrolysis with carbon capture, and electrolysis of water. All of these methods suffer from at least one of the following problems: (i) relying on fossil fuels; (ii) being inefficient; (iii) being expensive to manufacture, install and run; and/or (iv) lack of flexibility in operation.

It would be desirable to provide a scalable, efficient, low carbon hydrogen production system and method.

### SUMMARY OF THE INVENTION

From a first aspect, the invention provides a system for producing hydrogen from water by a thermochemical cycle comprising at least one reaction, the system comprising a reactor configured to implement the thermochemical cycle, the reactor comprising:
at least one fluid circuit;
means for driving fluid around said at least one fluid circuit;
a respective reaction zone for implementing the, or each, reaction, or a respective one or more of said at least one reaction, the or each reaction zone being connected to said at least one fluid circuit, wherein said reactor is configured to:
direct at least one reaction product from at least one of said at least one reaction to the respective reaction zone of at least one other of said at least one reaction to provide at least one reactant for said at least one other of said at least one reaction; and/or
to recirculate fluid around said at least one fluid circuit whereby at least one reaction product from at least one of said at least one reaction is recirculated to the respective reaction zone of at least one of said at least one reaction to provide at least one reactant for said at least one of the at least one reaction.

Advantageously, reaction zones are interconnected by the fluid circuit(s) and the reactor is configured to direct reaction product(s) from one or more reaction zone to one or more other reaction zone to provide reactant(s) for the, or each, other reaction zone. Advantageously, fluid is recirculated around the fluid circuit(s) so that reaction product(s) from one or more downstream reaction zone(s) are reused as reactant(s) for one or more upstream reaction zone(s). Heat generated in one or more reaction zone is advantageously reused, preferably by one or more heat exchanger, to heat fluid being delivered to one or more other reaction zones. The resulting system is energy efficient as well as being efficient in its use of reactants.

Preferably, said reactor is configured to recirculate at least one reaction product from at least one of said at least one reaction to the respective reaction zone of at least one other of said at least one reaction to provide at least one reactant for at least one of the respective at least one reaction.

In preferred embodiments, said at least one reaction comprises a first reaction and at least one other reaction (which is typically implemented in a reaction zone downstream of the reaction zone of the first reaction), said reactor being configured to recirculate at least one reaction product from at least one of said at least one other reaction to the respective reaction zone of said first reaction to provide at least one reactant for said first reaction.

Preferably, said at least one reaction comprises a first reaction and at least one other reaction (which is typically implemented in a reaction zone downstream of the reaction zone of the first reaction), said reactor being configure to direct at least one reaction product from said first reaction to the respective reaction zone of at least one of said at least one other reaction to provide at least one reactant for said at least one of said at least one other reaction.

The system optionally includes at least one reservoir for storing at least one reactant, wherein said reactor is configured to recirculate at least one reaction product from at least one of said at least one reaction to said at least one reservoir for delivery to the respective reaction zone.

The system preferably includes at least one heat exchanger configured to perform heat exchanging between fluid exiting at least one reaction zone and fluid being delivered to at least one reaction zone.

In preferred embodiments, the system includes a control system configured to control at least one parameter (or characteristic) of fluid in said at least one fluid circuit in order to implement said at least one reaction in the respective reaction zone, wherein said at least one parameter may comprise any one or more of: fluid composition; fluid temperature; fluid flow rate; fluid pressure; fluid level.

In preferred embodiments, the system of any preceding claim, further including means for heating fluid in said reactor.

In some embodiments, said thermochemical cycle is the Sulphur-iodine cycle, and the reactor comprises:
a first reaction zone for implementing a first reaction in which first reactants water, Sulphur dioxide and iodine react to form first reaction products sulphuric acid and hydrogen iodide;
a second reaction zone for implementing a second reaction involving decomposition of second reactant sulphuric acid into second reaction products Sulphur dioxide, oxygen and water;
a third reaction zone for implementing a third reaction involving decomposition of third reactant hydrogen iodide into third reaction products iodine and hydrogen; and preferably
at least one reservoir for storing said first reactants, wherein said reaction zones and said at least one reservoir when present are inter-connected by said at least one fluid circuit, and wherein said at least one reservoir when present and said first reaction zone are located in a first portion of said fluid circuit, said first circuit portion branching into a second circuit portion and a third circuit portion downstream of said first reaction zone, said second reaction zone being located in said second circuit portion and said third reaction zone being located in said third circuit portion, and wherein said second and third circuit portions are connected to said first circuit portion downstream of said second reaction zone and said third reaction zone respectively, and wherein the reactor further includes means for separating said first reaction products, said reactor being configured to direct the separated sulphuric acid to said second reaction zone and the separated hydrogen iodide to said third reaction zone, and wherein said reactor is configured to direct the second reaction product Sulphur dioxide to said first reaction zone, preferably via said at least one reservoir when present, and to direct the third reaction product iodine to said first reaction zone, preferably via at least one reservoir when present.

Typically, the system includes means for separating said second reaction products, said reactor being configured to direct the separated Sulphur dioxide to said first reaction zone, preferably via said at least one reservoir when present; and/or means for separating said third reaction products, said reactor being configured to direct the separated iodine to said first reaction zone, preferably via said at least one reservoir when present.

Said at least one reservoir is typically located upstream of said first reaction zone and preferably comprises a first reservoir for storing water and iodine, preferably a suspension of iodine in water, and a second reservoir for storing Sulphur dioxide, preferably in gaseous form.

Said driving means may comprise means for delivering said first reactants to said first reaction zone from said at least one reservoir under pressure, and wherein said driving means optionally comprises a compressor for driving said Sulphur dioxide from said at least one reservoir, and a pump for driving said water and iodine from said at least one reservoir.

Said first circuit portion may be configured to deliver said first reactants to said first reaction zone separately, and may include at least one valve operable to control the flow of said first reactants to said first reaction zone.

Typically, said first reaction zone comprises a vessel, conduit or chamber and is preferably configured to heat and/or mix said first reactants to implement said first reaction, said first reaction zone typically including or being associated with at least one valve operable to control the flow of said first reaction products to said means for separating said second reaction products.

Typically, said heating means comprises at least one heating device for heating said first reactants to a desired temperature for said first reaction, said at least one heating device optionally being included in said first reaction zone.

Said means for separating said first reaction products may comprise a gravimetric separator, or other liquid separating apparatus.

Optionally, said reactor further includes at least one reservoir for storing the separated first reaction products, and preferably at least one valve operable to control the flow of the separated first reaction products to said at least one reservoir.

Optionally, said reactor is configured to direct the separated sulphuric acid to said second circuit portion from said at least one reservoir, and to direct the separated hydrogen iodide to said third circuit portion from said at least one reservoir, and preferably includes at least one valve operable to control the flow of the separated first reaction products from said at least one reservoir to said first and second circuit portions.

Said at least one reservoir may comprise a third reservoir for storing said sulphuric acid, preferably in liquid form, and a fourth reservoir for storing said hydrogen iodide, preferably in liquid form.

Typically, said second reaction zone comprises a vessel, conduit or chamber and is preferably configured to heat said second reactant in order to implement said second reaction, said second reaction zone preferably including a catalyst to facilitate said second reaction.

Said heating means may comprise at least one heating device for heating said second reactant to a desired temperature for said second reaction, and wherein said at least one heating device is optionally included in said second reaction zone or otherwise associated with said second reaction zone.

Preferably, the heating means for said second reaction zone comprises a furnace, preferably an electric furnace, more preferably a high thermal inertia electric furnace, or other electrically powered heating apparatus.

Typically, said means for separating said second reaction products comprises at least one condenser, or at least one other gas or vapour separator, said separating means preferably comprising a water condenser and/or a Sulphur dioxide condenser. Said separating means may comprise a Sulphur dioxide condenser for separating Sulphur dioxide from said second reactant products in liquid form, and an evaporator for converting said liquid Sulphur dioxide to a vapour or gaseous state.

In preferred embodiments, said first circuit portion includes a return part configured to deliver fluid to said at least one reservoir for storing said first reactants (if present), or otherwise to deliver fluid directly or indirectly to the first reaction zone. The second circuit portion is preferably configured to deliver the separated Sulphur dioxide to said return part, wherein said separated Sulphur dioxide is preferably returned to said at least one reservoir, or otherwise to the first reaction zone, in vapour or gaseous form.

Said means for separating said second reaction products may comprise or be associated with at least one valve operable to control the flow of said separated second reaction products.

Typically, said third reaction zone comprises a vessel, conduit or chamber and is preferably configured to heat said third reactant in order to implement said third reaction.

Typically, said heating means comprises at least one heating device for heating said third reactant to a desired temperature for said third reaction, and wherein said at least one heating device is optionally included in said third reaction zone or otherwise associated with said third reaction zone. The heating means for said third reaction zone preferably comprises a furnace, preferably an electric furnace, more preferably a high thermal inertia electric furnace, or other electrically powered heating apparatus.

Typically, said means for separating said third reaction products comprises at least one condenser, or at least one other gas or vapour separator, said separating means preferably comprising a water condenser and/or an iodine condenser.

Optionally, said reactor includes a mixer for mixing said separated iodine with water, said reactor being configured to direct the separated iodine mixed with water to said at least one reservoir, or otherwise directly or indirectly to said first reaction zone, and wherein preferably said mixer is arranged to mix said separated iodine with water separated from said third reaction products.

In preferred embodiments, said first circuit portion includes a return part configured to deliver fluid to said at least one reservoir for storing said first reactants, or otherwise to deliver fluid directly or indirectly to said first reaction zone, and wherein said third circuit portion is configured to deliver the separated iodine to said return part for delivery to said at least one reservoir for storing said first reactants or otherwise directly or indirectly to said first reaction zone, wherein said separated iodine is preferably returned to said at least one reservoir or said first reaction zone mixed with water.

Said means for separating said third reaction products may comprise or be associated with at least one valve operable to control the flow of said separated third reaction products.

In preferred embodiments, said reactor includes at least one heat exchanger arranged to perform heat exchanging between said second reactant and at least one of said second reaction products and said third reaction products, whereby said second reactant is heated by said second reaction products and/or third reaction products, and said second and/or third reaction products are cooled by said second reactant. Said at least one heat exchanger may be provided in said second circuit portion, and be arranged to receive said second reactant and said second reaction products, and to perform heat exchanging whereby said second reactant is heated by said second reaction products, and said second reaction products are cooled by said second reactant.

Preferably, said reactor includes at least one heat exchanger arranged to perform heat exchanging between said third reactant and at least one of said second reaction products and said third reaction products, whereby said third reactant is heated by said second reaction products and/or third reaction products, and said second and/or third reaction products are cooled by said third reactant. Said at least one heat exchanger may be provided in said third circuit portion, and be arranged to receive said third reactant and said third reaction products, and to perform heat exchanging whereby said third reactant is heated by said third reaction products, and said third reaction products are cooled by said third reactant.

In preferred embodiments, a plurality of control zones are included in said fluid circuit at a respective different location, each control zone including at least one device for controlling at least one parameter (or characteristic) of said fluid in accordance with control information and/or at least one parameter measurement device, the system further including a control system for controlling operation of the reactor, the control system being in communication with said control zones to provide each control zone with said control information and/or to receive parameter measurement information from the control zone. Said at least one parameter may comprise a respective parameter indicating any one or more of: fluid composition; fluid temperature; fluid flow rate; fluid pressure; fluid level. Optionally, the control system is configured to calculate said control information by mathematically modelling said reactor using Model Predictive Control (MPC).

Advantageously, the control system is configured to determine said control information using a mathematical model of the reactor, and wherein said mathematical model preferably comprises a neural network model whereby said control system is configured to calculate said control information using an artificial neural network.

Said means for separating said third reaction products may comprise means for separating said hydrogen and means for venting, storing and/or collecting the separated hydrogen.

From a second aspect the invention provides a method of producing hydrogen from water by a thermochemical cycle comprising at least one reaction, the method comprising:
implementing the, or each, reaction or a respective one or more of said at least one reaction, in a respective reaction zone of a reactor to produce at least one reaction product from at least one reactant,
wherein the, or each, reaction zone is connected to at least one fluid circuit of said reactor, and wherein the method further comprises:
   directing at least one reaction product from at least one of said at least one reaction to the respective reaction zone of at least one other of said at least one reaction to provide at least one reactant for said at least one other of said at least one reaction; and/or
   recirculating fluid around said at least one fluid circuit, said recirculating comprising recirculating at least one reaction product from at least one of said at least one reaction to the respective reaction zone of at least one of said at least one reaction to provide at least one reactant for said at least one of the at least one reaction.

Preferably, said recirculating comprises recirculating at least one reaction product from at least one of said at least one reaction to the respective reaction zone of at least one other of said at least one reaction to provide at least one reactant for at least one of the respective at least one reaction.

Preferably, said at least one reaction comprises a first reaction and at least one other reaction, and said method includes recirculating at least one reaction product from at least one of said at least one other reaction to the respective reaction zone of said first reaction to provide at least one reactant for said first reaction.

Preferably, said at least one reaction comprises a first reaction and at least one other reaction, and said method including directing at least one reaction product from said first reaction to the respective reaction zone of at least one of said at least one other reaction to provide at least one reactant for said at least one of said at least one other reaction.

The method may include storing at least one reactant in at least one reservoir, and wherein said recirculating involves recirculating at least one reaction product from at least one of said at least one reaction to said at least one reservoir for delivery to the respective reaction zone.

Preferably, the method includes performing heat exchanging between fluid exiting at least one reaction zone and fluid being delivered to at least one reaction zone.

Preferably, the method includes controlling at least one parameter of fluid in said at least one fluid circuit in order to implement said at least one reaction in the respective reaction zone, wherein said at least one parameter may comprise any one or more of: fluid composition; fluid temperature; fluid flow rate; fluid pressure; fluid level.

In some embodiments, the thermochemical cycle is the sulphur-iodine cycle, and the method comprises: implementing, in a first reaction zone of the reactor, a first reaction in which first reactants water, Sulphur dioxide and iodine react to form first reaction products sulphuric acid and hydrogen iodide; implementing, in a second reaction zone of the reactor, a second reaction involving decomposition of second reactant sulphuric acid into second reaction products Sulphur dioxide, oxygen and water; implementing, in a third reaction zone of the reactor, a third reaction involving decomposition of third reactant hydrogen iodide into third reaction products iodine and hydrogen; optionally storing said first reactants in at least one reservoir; separating said first reaction products, and delivering the separated sulphuric acid to said second reaction zone and the separated hydrogen iodide to said third reaction zone; directing the second reaction product Sulphur dioxide to said first reaction zone, preferably via said at least one reservoir when present; and directing the third reaction product iodine to said first reaction zone, preferably via said at least one reservoir when present.

Typically, the method includes separating said second reaction products, and delivering the separated Sulphur dioxide to said at least one reservoir if present or otherwise directly or indirectly to said first reaction zone; and/or separating said third reaction products, and delivering the separated iodine to said at least one reservoir if present or otherwise directly or indirectly to said first reaction zone.

In preferred embodiments hydrogen (H₂) is generated in a recirculating gas reactor by means of the sulphur-iodine cycle (S-I cycle), advantageously involving catalysis. Preferred embodiments provide a low carbon production method of hydrogen to lessen the environmental impact for large scale production, or widespread distributed production.

In preferred embodiments, hydrogen is produced in a thermo-cyclic H₂ production reactor. Advantageously, hydrogen is produced using less energy and more cost effectively by utilising a multi-stage thermochemical reaction cycle based on the Bunsen reaction in the S-I cycle when compared to the conventional approach using electrolysis of water. Advantageously, fluid, in particular gas, is recirculated in the reactor to provide efficient use of heat and reactants. The production process is therefore low-energy and cost-efficient, producing green hydrogen gas (and oxygen as a by-product) from water and renewable electricity. Advantageously, the recirculating reactor includes a control system that creates control zones to facilitate each individual thermochemical reaction. Thermal and chemical degradation of materials at high temperatures (up to 1090° C.) can readily be managed. Producing hydrogen close to renewable energy sources such as a windfarm is highly desirable as the energy is transformed at site. However, wind is variable, frequency not matched to electrical demand on the grid, and does not work well directly with electrolysis machines as they require a steady supply. Preferred embodiments of the invention use one or more high thermal-inertia, electric tube furnace(s) that can directly load follow and adjust H₂ production based on the total excess power available at the wind farm or individual turbine. Additionally, preferred embodiments of the invention use one or more fluid reservoirs as thermal inertias to absorb (and store) as heat energy excess electrical power available at the wind farm or individual turbine. This reduces the need for other additional plant at site such as high-cost battery materials that are in high demand due to the electrification of vehicles.

From another aspect, the invention provides a system for producing hydrogen, the system comprising a reactor configured to implement the Sulphur-iodine cycle, the reactor comprising:
at least one fluid circuit;
means for driving fluid around said at least one fluid circuit;
a first reaction zone for implementing a first reaction in which first reactants water, Sulphur dioxide and iodine react to form first reaction products sulphuric acid and hydrogen iodide;
a second reaction zone for implementing a second reaction involving decomposition of second reactant sulphuric acid into second reaction products Sulphur dioxide, oxygen and water;
a third reaction zone for implementing a third reaction involving decomposition of third reactant hydrogen iodide into third reaction products iodine and hydrogen;
at least one reservoir for storing said first reactants; and
means for heating fluid in said reactor,
wherein said reaction zones and said at least one reservoir are inter-connected by said at least one fluid circuit,
and wherein said at least one reservoir and said first reaction zone are located in a first portion of said fluid circuit, said first circuit portion branching into a second circuit portion and a third circuit portion downstream of said first reaction zone, said second reaction zone being located in said second circuit portion and said third reaction zone being located in said third circuit portion, and
wherein said second and third circuit portions are connected to said first circuit portion downstream of said second reaction zone and said third reaction zone respectively,
and wherein the reactor further includes means for separating said first reaction products, said reactor being configured to direct the separated sulphuric acid to said second reaction zone and the separated hydrogen iodide to said third reaction zone,
and wherein said reactor is configured to direct the second reaction product Sulphur dioxide to said at least one reservoir, and to direct the third reaction product iodine to said at least one reservoir.

From a further aspect the invention provides a method of producing hydrogen by the sulphur-iodine cycle, the method comprising:
implementing, in a first reaction zone of a reactor, a first reaction in which first reactants water,
Sulphur dioxide and iodine react to form first reaction products sulphuric acid and hydrogen iodide;
implementing, in a second reaction zone of the reactor, a second reaction involving decomposition of second reactant sulphuric acid into second reaction products Sulphur dioxide, oxygen and water;
implementing, in a third reaction zone of the reactor, a third reaction involving decomposition of third reactant hydrogen iodide into third reaction products iodine and hydrogen;
storing said first reactants in at least one reservoir;
separating said first reaction products, and delivering the separated sulphuric acid to said second reaction zone and the separated hydrogen iodide to said third reaction zone;
directing the second reaction product Sulphur dioxide to said at least one reservoir; and
directing the third reaction product iodine to said at least one reservoir.

Preferred embodiments of the invention are relatively efficient in terms of energy and reactant usage in comparison with known hydrogen production methods. Typically, embodiments of the invention exhibit energy efficiency in the order of 70%, but this may be higher or lower. Embodiments of the invention may for example consume power in the range 50-500 KW, or higher, e.g. up to 20 MW. Preferred embodiments of the invention are suitable for installation at a renewable energy site, e.g. a wind farm, for utilisation of available unused power at the renewable energy site, but may be scalable for larger capacity use. Use of electric furnace(s) (and/or other electrically powered heating apparatus) also facilitates integration with renewable energy supplies.

Preferred embodiments of the invention are suitable for incorporation into a cascaded energy system in which respective components of the cascaded system (any one of which may comprise an embodiment of the present invention) are provided with energy in a cascaded manner, e.g, wherein a first component may receive energy from a primary energy source (e.g. wind or solar energy source(s)), a second component may receive highest grade waste heat energy, and third component may receive lower grade, secondary or excess waste heat energy, and so on. The cascaded energy system may be configured to cascade energy usage in terms of primary energy and utilisation of waste heat in any suitable manner (e.g. process/component A uses the highest grade waste heat, the waste heat is then used to support process/component B, before finally supporting process/component C).

In preferred embodiments, a single recirculating reactor is configured to implement the S-I cycle, the reactor facilitating cyclic operation resulting in efficient use of energy and reactants. Advantageously, the use of heat exchangers facilitates energy efficiency. Advantageously, heat exchangers are configured to allow the reactor to efficiently control the rate of each individual reaction to best utilize available energy over time where a fluctuating energy source is used. Advantageously, Al based model control can be used to optimize reactor operation in real time, e.g. in order to make best use of available energy and reactant levels. Advantageously, the thermal inertia of components (in particular furnaces) allows the reactor to be highly tolerant of a fluctuating energy supply (e.g. a renewable energy supply). Advantageously, systems embodying the invention are relatively small and are suited to integration with a renewable energy source, e.g. wind turbine(s). Use of electric furnace(s) (and/or other electrically powered heating apparatus) also facilitates integration with renewable energy supplies.

Preferred embodiments of the system include a recirculating fluid reactor that is energy efficient and allows precise control of chemical composition, flow and temperature in one or more reaction zones where the reactants are converted to products by chemical reaction. Advantageously, mathematical model-based control is implemented at one or more control zones. Typically, operation of the reactor involves delivery of one or more gases and/or liquids into a closed system, or zone, of fixed known volume. Triangulation of multiple measurement sources, predictive models and calibrated gas/liquid delivery systems can ensure accuracy in a dynamic environment.

In preferred embodiments, the recirculating gas or liquid (fluid) production reactor comprises at least one, normally two or more, recirculating gas systems/circuits with integral furnace(s), storage reservoir(s) and blower(s) or other fluid drive means. Heat is regenerated through an integral heat exchanger(s) and may be stored throughout the thermal inertia of the system.

Further advantageous aspects of the invention will be apparent to those ordinarily skilled in the art upon review of the following description of a specific embodiment and with reference to the accompanying drawings.

### BRIEF DESCRIPTION OF THE DRAWINGS

An embodiment of the invention is now described by way of example and with reference to the accompanying drawings in which like numerals are used to denote like parts and in which:

FIG. 1 is an illustration of the sulphur-iodine cycle;

FIG. 2 is a schematic diagram of a hydrogen production system embodying one aspect of the invention; and

FIG. 3 is an alternative schematic diagram of the system of FIG. 2, including a control system.

### DETAILED DESCRIPTION OF THE DRAWINGS

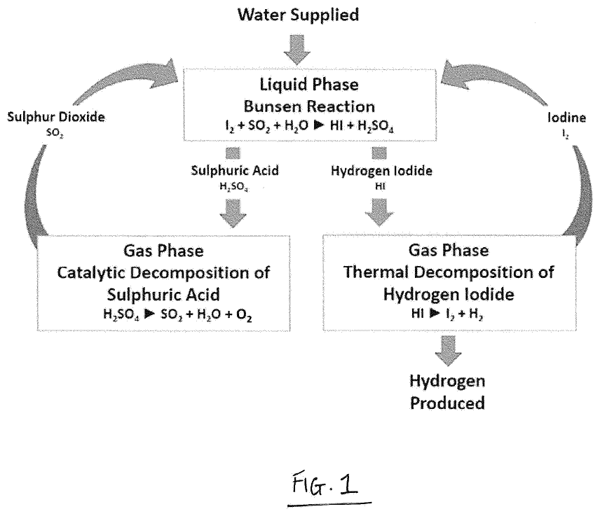

Thermochemical cycles combine heat source(s) with chemical reactions to split water into its hydrogen and oxygen components. FIG. 1 illustrates a thermochemical cycle for producing hydrogen (H₂), in particular hydrogen (H₂) gas, which may be referred to as thermo-cyclic hydrogen production. In particular, FIG. 1 illustrates the sulphur-iodine cycle (S-I cycle).

The S-I cycle consists of three chemical reactions. The first reaction is provided below and is commonly referred to as the Bunsen reaction:

I₂+SO₂+2H₂O+ₕₑₐₜ→+2HI+H₂SO₄ (Reaction 1)

Reaction 1 is an exothermic reaction and may for example take place at 120° C., or optionally in the range 100° C. to 150° C. The reactants are initially heated to sufficient temperature to initiate the Bunsen reaction. Following this, the energy released from the reaction is removed from the system, which can preferably be realised through passive cooling or heat loss, optionally through active cooling. The hydrogen iodide and sulphuric acid may be separated by any suitable means, e.g. distillation or liquid/liquid granitic separation.

The second reaction involves decomposition of the sulphuric acid:

2H₂SO₄+ₕₑₐₜ→2SO₂+2H2O+O₂ (Reaction 2)

Reaction 2 is an endothermic reaction and may for example take place at 830° C., or other suitable temperature. Reaction 2 can be performed at very high temperature, but a catalyst may optionally be involved to reduce activation energy and hence improve energy efficiency. The produced oxygen may be separated from the water, SO₂ and any residual sulphuric acid using any convenient separation means, e.g. condensation.

The third reaction involves thermally decomposing the hydrogen iodide:

2HI+ₕₑₐₜ→I₂+H₂ (Reaction 3)

Reaction 3 is an endothermic reaction and may for example take place at 450° C. or other suitable temperature. Reaction 3 can be achieved at high temperature, but a catalyst may optionally be involved to reduce activation energy and hence improve energy efficiency. The produced hydrogen may be separated from the iodine (and any water or SO₂ that may be present) using any convenient separation means, e.g. condensation, wherein the hydrogen product typically remains as a gas.

It can be seen from Reactions 1 to 3, that the net reactant of the S-I cycle is water and the net products are hydrogen and oxygen. The sulphur dioxide from Reaction 2 and the iodine from Reaction 3 are recovered and reused in Reaction 1. Heat enters the S-I cycle in the endothermic chemical Reactions 2 and 3, and heat exits the cycle in the exothermic Reaction 1. Typically, the S-I cycle requires the input of heat energy and a supply of water.

In preferred embodiments of the invention, a recirculating fluid (gas and/or liquid) reactor is used to recycle the reacted iodine and sulphur dioxide to be used again in the Bunsen reaction.

In preferred embodiments, the recirculating gas or liquid (fluid) production reactor comprises at least one, optionally two or more, recirculating gas or fluid circuits, each typically including one or more furnace, storage reservoir and blower. Heat is regenerated through one or more heat exchanger and may be stored throughout the reactor. In typical embodiments, the first stage of the Bunsen reaction is a liquid stage and is followed by separation of sulphuric acid and hydrogen iodide.

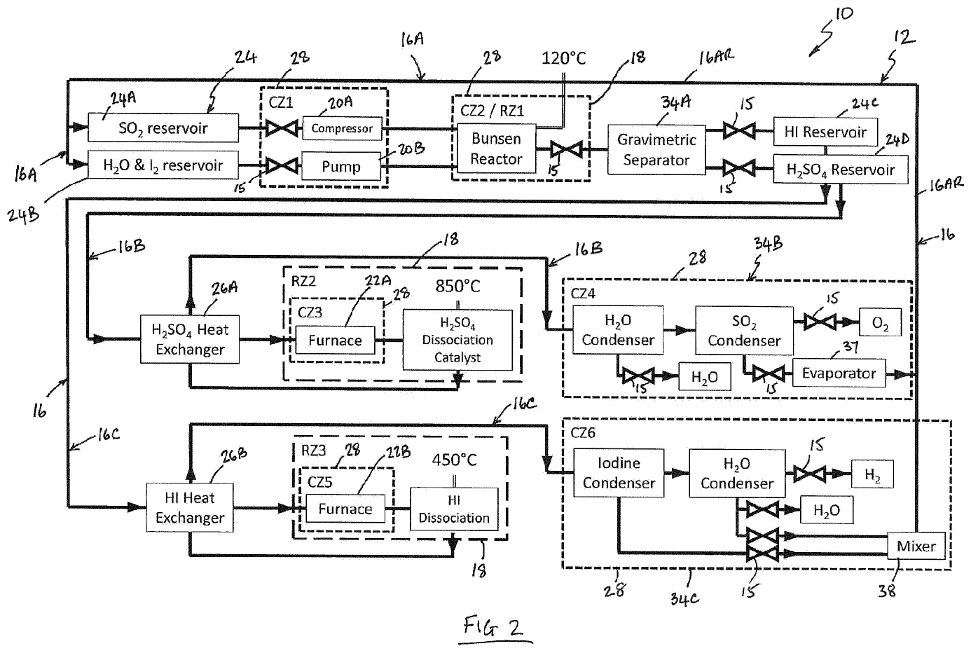

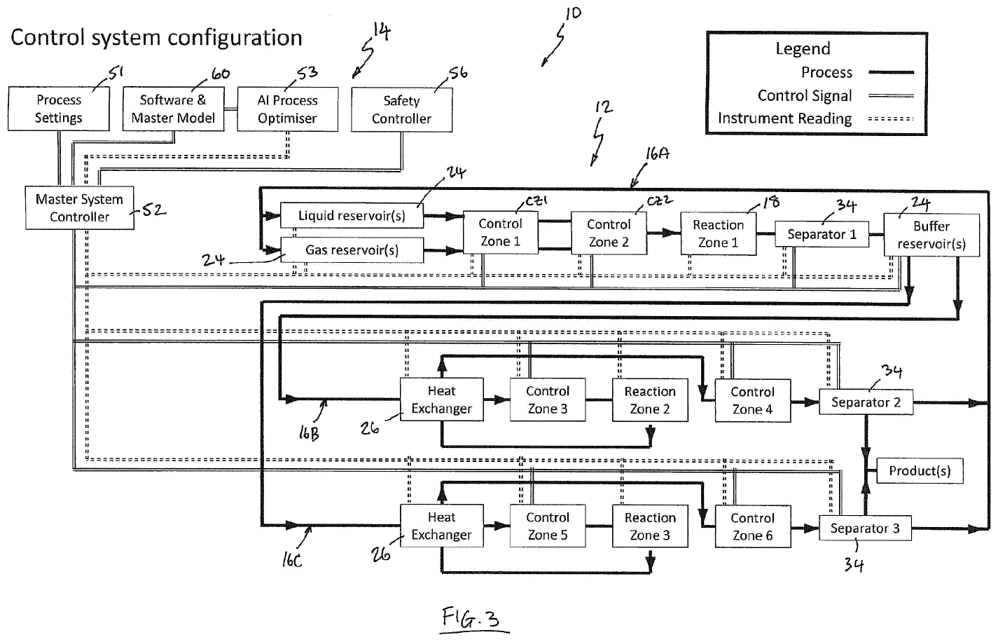

Referring now to FIGS. 2 and 3, there is shown, generally indicated as 10, a hydrogen production system embodying one aspect of the invention. The hydrogen production system 10 includes a reactor 12 and a control system 14 for controlling the operation of the reactor 12. The reactor 12 is intended to cause and control chemical reactions in use and may be described as a chemical reactor. The reactor 12 includes one or more fluid circuits by which fluid (gas and/or liquid) may be recirculated within the reactor 12 and, as such, the reactor 12 may be described as a recirculating fluid reactor. In preferred embodiments, the system 10, and in particular the reactor 12, is configured to implement a thermochemical cycle for producing hydrogen (H₂), in particular hydrogen (H₂) gas, by splitting water into its hydrogen and oxygen components, i.e. to implement thermo-cyclic hydrogen production. Advantageously, the system 10 is configured to implement the three reactions of the sulphur-iodine cycle (S-I cycle) in the recirculating fluid reactor 12, as is described in more detail below. In alternative embodiments, the system may be configured to implement any alternative thermochemical cycle for splitting water into hydrogen and oxygen.

The reactor 12 comprises a fluid circuit 16 around which fluid is circulated, and advantageously recirculated, during use. In preferred embodiments, the fluid circuit 16 has a first circuit portion 16A that branches into second and third circuit portions 16B, 16C that subsequently recombine with the first circuit portion 16A. The fluid circuit 16 may be of any convenient construction, typically including any one or more of: pipe(s), tube(s), hosing, duct(s) and/or other fluid conduits. These may be formed from any convenient material, e.g. metal or plastics, and may optionally be thermally insulated and/or protected with one or more corrosion resistant coating.

The fluid circuit 16 includes a respective reaction zone 18 for implementing each reaction that is part of the hydrogen production process. In preferred embodiments, the fluid circuit 16 includes reaction zone 1 (labelled as RZ1 in FIG. 2) for implementing Reaction 1 (the Bunsen reaction), reaction zone 2 (labelled as RZ2 in FIG. 2) for implementing Reaction 2, and reaction zone 3 (labelled as RZ3 in FIG. 2) for implementing Reaction 3. Advantageously, reaction zone 1 is included in the first circuit portion 16A, reaction zone 2 is included in the second circuit portion 16B, and reaction zone 3 is included in the third circuit portion 16C. The reactor configuration is such that the sulphuric acid produced by Reaction 1 in reaction zone RZ1 flows to reaction zone RZ2 via the second circuit portion 16B, and the hydrogen iodide produced by Reaction 1 in reaction zone RZ1 flows to reaction zone RZ3 via the third circuit portion 16C. The reactor 12 is further configured such that the sulphur dioxide produced by Reaction 2 in reaction zone RZ2 is returned to the first circuit portion 16A for supply to reaction zone RZ1 for use in Reaction 1, and that the iodine produced by Reaction 3 in reaction zone RZ3 is returned to the first circuit portion 16A for supply to reaction zone RZ1 for use in Reaction 1.

In typical embodiments, fluid phase in each region of the reactor 12 may be determined by process conditions. Typically, the Bunsen reaction is liquid phase because at the relevant process (reaction) temperatures the reactants (excluding SO2) and products are liquid. HI and sulphuric acid decomposition typically starts with liquid but the reaction occurs in gaseous phase (due to temperature). The phases across each region of the reactor may be leveraged to drive fluid flow by heating of the liquid to produce vapour at high pressure. Fluid flow in the circuit may also be optionally driven by one or more additional pumps or other fluid driving device(s) at one or more locations in the fluid circuit as required.

Each reaction zone 18 may take any suitable form, for example comprising a chamber or vessel incorporated into the respective circuit portion 16A, 16B, 16C or being a part of a conduit that forms the circuit portion 16A, 16B, 16C. Each reaction zone 18 is in fluid communication with the respective fluid circuit portion 16A, 16B, 16C such that fluid may be delivered to and from the reaction zone 18 during use.

The reactor 12 typically includes, or is connected to, one or more fluid reservoirs 24 for storing quantities of gas and/or liquid, and which may also store energy (i.e. by storing fluid at a temperature that is elevated compared to the fluid in the circuit). Active heating of the reservoir(s), using any convenient heating means, e.g. a respective heating device for the, or each reservoir, may optionally be implemented to utilize excess available renewable energy (e.g. from a wind farm, wind turbine or other renewable energy source to which the system 10 may be connected in use) when available. Such heating leverages the high thermal inertia of the stored fluid(s) to reduce the heating requirement of the reactor during subsequent periods of relatively lower energy availability. The thermal inertia of the stored reactants allows the reactor 12 to operate effectively under variable or fluctuating energy supply. In preferred embodiments, the reactor 12 includes, or is connected to, at least one reservoir 24A, 24B for storing the reactants for Reaction 1. In particular, reservoir 24A may be provided for storing Sulphur dioxide, while reservoir 24B may be provided for storing water and iodine. The reservoir(s) 24A, 24B are conveniently included in, or connected to, the first circuit portion 16A and are located upstream of the reaction zone RZ1 in order to provide the relevant reactant(s) to the reaction zone RZ1 via the first circuit portion 16A. Advantageously, the reactor 12 is configured such that the sulphur dioxide produced by Reaction 2 in reaction zone RZ2 is returned to the respective reservoir by the first circuit portion 16A, and that the iodine produced by Reaction 3 in reaction zone RZ3 is returned to the respective reservoir by the first circuit portion 16A. Optionally, the reactor 12 includes, or is connected to, at least one reservoir 24C, 24D for storing the products of Reaction 1. In particular, reservoir 24C may be provided for storing hydrogen iodide, while reservoir 24D may be provided for storing sulphuric acid. The reservoir(s) 24C, 24D are conveniently included in, or connected to, the first circuit portion 16A and are located downstream of the reaction zone RZ1 in order to receive the relevant products from the reaction zone RZ1 via the first circuit portion 16A.

In preferred embodiments, the SO2 is stored as a gas. It is also preferred that the I₂ is suspended (as a liquid or a solid depending on temperature and/or pressure) in water to facilitate delivery to reaction zone RZ1. Further water is advantageously used as a carrier for the iodine since in case temperature falls sufficiently to result in solidification of the I₂. Also, water is required in the Bunsen reaction, with liquid phase reactants (or liquid+suspended solids phase) preferably stored in one reservoir. HI and sulphuric acid are preferably stored as liquids, e.g. in an accumulator type reservoir (in which the presence of inert gas allows reservoir pressure to be easily controlled in order to drive flow through the reactor 12). Typically, storage in liquid form is dictated by the temperature of reaction products from RZ 1/vessel storage temperatures.

The reactor 12 typically includes fluid driving means 20 for causing the fluid to flow around the fluid circuit 16. In the illustrated embodiment, the fluid driving means 20 comprises a compressor 20A and a pump 20B. More generally the fluid driving means 20 may any conventional form, e.g. one or more fans or blowers (for example including axial fans, propeller fans, centrifugal (radial) fans, mixed flow fans and cross flow fans), pumps (e.g. centrifugal pumps or positive displacement pumps), compressors and/or turbines. The fluid driving means 20 are preferably controllable to control the flow, and in particular the flow rate, of fluid around the fluid circuit 16. Flow of fluid around the circuit 16 may also be controllable using one or more valves 15, and/or may be assisted by one or more additional pumps or other fluid driving device(s) at one or more locations in the fluid circuit as required, e.g. after separator 34A one or more pump or other fluid driving device may be provided for transferring fluid to the storage reservoirs 24A and 24B.

The reactor 12 includes heating means 22 for controlling the temperature of fluid in the circuit 16, particularly in the reaction zones 18. In typical embodiments, the heating means comprises one or more furnace, but may alternatively comprise any other suitable heating apparatus or device, e.g. a boiler. The heating means typically comprises a containment or pressure flow conduit for a thermal mass for storage and transfer of heat. The heating apparatus may include any conventional heating device(s), e.g. electrical, gas or liquid fuel combustion or heat exchange type(s). In the illustrated embodiment, a first furnace 22A is included in or associated with reaction zone RZ2, and a second furnace 22B is included in or associated with reaction zone RZ3. Other heating devices may be provided in the reactor 12 as is described in more detail hereinafter. The heating means 22 may for example comprise chemical or gas furnaces (e.g. a propane or natural gas furnace) or electrical furnaces (e.g. an infra red furnace, electrical tube furnace or flat bed furnace) or any other convenient heating device including electrical heater(s), infra red heater(s), gas heater(s) and/or heat lamp(s) (e.g. quartz or tungsten heat lamps). Use of electrically powered furnaces and/or other electrically powered heating devices is preferred as it facilitates integration with a renewable energy supply, rather than utilizing waste heat from nuclear power process. Advantageously, the thermal inertia of components (in particular furnaces and reservoirs) allows the reactor 12 to be highly tolerant of a fluctuating energy supply (e.g. a renewable energy supply). The heating means 22 are preferably controllable to control and/or modulate the temperature of the fluid in the respective part of the circuit 16 and so to control and/or modulate a base temperature in the respective reaction zone 18 and/or control the temperature of the reactants as required. Each furnace or other heating apparatus may include any one or more of the following components: flow control and/or pressure regulating valve(s) with remote actuator(s) and/or mass flow controller(s) or other fluid injector(s); flow measurement device(s); pressure measurement device(s); temperature measurement device(s), fluid level and/or composition measurement device(s), each of which may be controlled by the control system 14 and/or provide information to the control system 14 as required.

In some embodiments, the reactor, or more particularly the fluid circuit 16, may be coupled to external heating means (not shown) configured to provide heat energy to the reactor, e.g. for controlling the temperature of fluid in the fluid circuit 16, the heat energy advantageously being waste heat energy. The external heating means may comprise an external apparatus or system configured to perform an industrial process, e.g. cement production, glass production, steel production and/or any other waste heat producing industrial process. The external heating means may be coupled to the reactor, or more particularly the fluid circuit 16, by any suitable conventional coupling means (e.g. one or more heat exchanger) and/or via any convenient heat exchanging medium (e.g. steam) in order that heat energy, preferably waste heat energy, may be transferred to the reactor/fluid circuit. For example, in the illustrated embodiment, one or more external heating means may be coupled to the fluid circuit 16 at the locations of any one or more of the furnaces 22 (as well as or instead of the furnaces).

The reactor 12 optionally includes one or more heat exchanger 26 to improve the efficiency of the reactor 12 in particular with respect to maintaining desired fluid temperatures in the reactor 12 energy efficiently. The heat exchangers 26 may be gas to gas type, gas to liquid type or liquid to liquid type as appropriate. In the illustrated embodiment, heat exchanger 26A is included in circuit portion 16B and is configured to heat the sulphuric acid that is delivered to reaction zone RZ2 using heat from the products produced by Reaction 2 in reaction zone RZ2, i.e. sulphur dioxide, oxygen and water. In the illustrated embodiment, heat exchanger 26B is included in circuit portion 16C and is configured to heat the hydrogen iodide that is delivered to reaction zone RZ3 using heat from the products produced by Reaction 3 in reaction zone RZ3, i.e. hydrogen, iodine and any water or SO2 that may be present. In alternative embodiments (not illustrated), the heat exchangers may be arranged such that heat exchanging is performed between the reactants for Reaction 2 and the reaction products from either or both of Reaction 2 and Reaction 3, and/or that heat exchanging is performed between the reactants for Reaction 3 and the reaction products from either or both of Reaction 2 and Reaction 3.

In preferred embodiments, the reactor 12 includes a plurality of control zones 28. Each control zone 28 is incorporated into the fluid circuit 16 at a respective location. Any one or more of the control zones 28 may be equipped to measure at least one aspect of the reactor's operation. Each control zone 28 may be configured to measure one or more characteristic, or parameter, of the fluid at the respective location in the respective fluid circuit 16 into which it is incorporated. As is described in more detail hereinafter, each control zone 28 may for example be configured to measure any one or more of the following fluid characteristics: flow rate, temperature, chemical composition, pressure, and may include any suitable conventional measurement device(s) for this purpose. Any one or more of the control zones 28 may be configured to control one or more characteristic of the fluid in the fluid circuit 16, e.g. the fluid flow rate, temperature, pressure and/or chemical composition, and/or to divert, direct or otherwise control the flow of the fluid, e.g. to a vent or to another component of the reactor 12. To this end, each control zone 28 may include one or more control devices, e.g. one or more valves 15, fluid injectors or fluid mixing devices, as described in more detail hereinafter. Any one or more of the respective control device(s) may be located at the respective control zone 28, in which case the control zone 28 controls the relevant fluid characteristic directly in its own locality. Alternatively, any one or more of the respective control device(s) may be located remotely from the respective control zone 28, in which case the control zone 28 controls the relevant fluid characteristic in one or more locations in the fluid circuit(s) remote from the control zone 28 itself. In such cases the control zone 28 may be said to include the control device in that it controls the operation of the control device.

In preferred embodiments, any one or more of the control zones 28 may be configured to monitor and control the introduction of one or more fluids (liquid(s) and/or gas(es) as applicable) into the fluid circuit 16 (e.g. to control reactant levels and/or concentrations). To this end, each such control zone 28 may comprise one or more fluid injectors and/or valves 15. Each fluid injector may take any conventional form, typically comprising one or more valves and conduit(s) connected to one or more fluid sources, e.g. a canister, a compressor and/or one or more of the reservoirs 24, usually pressured fluid sources. Each fluid source may contain a single fluid or a mixture of two more fluids, depending on the application and the tasks being performed by the respective control zone. Each fluid injector is operable to selectable inject one or more fluids into the respective fluid circuit(s) via one or more fluid inlets (not shown). Conveniently, the fluid inlet(s) are located at the respective control zone 28, although they may alternatively or additionally be located elsewhere in the fluid circuit(s). Conveniently, each fluid injector is located at the respective control zone 28, although they may alternatively or additionally be located elsewhere in the fluid circuit(s). Optionally, one or more fluid injectors (not shown) may be provided for injecting fluid(s) into the reservoir(s).

In preferred embodiments, each reaction zone 18 includes or is associated with at least one respective control zone 18, the or each respective control zone 28 is operable (by control system 14 in preferred embodiments) to control one or more of the characteristics of the fluid in the respective reaction zone 18. Preferably, the or each respective control zone 28 is included in or located upstream of the respective reaction zone 18 (preferably immediately upstream of the respective reaction zone 18, e.g. at a fluid inlet of the respective reaction zone 28). Each control zone 28 is equipped with one or more sensor/measurement device and/or one or more control device (e.g. valve and/or fluid injector) to allow it to monitor and/or control the relevant characteristic(s) of the fluid in the respective reaction zone 18.

In order to communicate with other components of the system 10, including for example remote analyser(s) and/or a control system, each control zone 28 may include a communications system including one or more wired and/or wireless communications devices as required.

The control zone 28 typically includes an enclosure in which at least some of its components are housed as is convenient. The enclosure may for example comprise a chamber incorporated into the circuit 16, or a chamber to which the circuit 16 is connected or passes through, or may comprise a part of one or more conduits that form the circuit 16.

In preferred embodiments, the reactor 12 includes at least one separator 34 for separating the products produced by the reactions implemented in the reaction zones 18. Each separator 34 may take any conventional form to suit the method by which the relevant products can be separated, e.g. condensation, distillation or liquid/liquid gravitic or gravitmetric separation. Preferably, a first separator 34A, which may for example comprise a gravimetric separation apparatus or other suitable separating device/apparatus, is provided in the first circuit portion 16A for separating the hydrogen iodide and sulphuric acid produced by Reaction 1 in reaction zone RZ1. The reactor 12 is configured to deliver the separated hydrogen iodide and sulphuric acid to the third and second circuit portions 16C, 16B respectively. In preferred embodiments, the reactor 12 is configured to deliver the separated products to the reservoirs 24C, 24D respectively, optionally via valves 15 and/or optionally assisted by one or more pump or other fluid driving device, before delivering them to the circuit portions 16C, 16B. Preferably, a second separator 34B, which may for example comprise a water condenser and a sulphur dioxide condenser or other suitable separating device(s)/apparatus, is provided in the second circuit portion 16B for separating the water, sulphur dioxide and oxygen produced by Reaction 2 in reaction zone RZ2. The reactor 12 is configured to deliver the separated sulphur dioxide to a return part 16AR of the first circuit portion 16A that delivers the sulphur dioxide to the reservoir 24A. Optionally, the reactor 12 includes an evaporator 37 for converting the sulphur dioxide to gaseous form for delivery to the reservoir 24A. Optionally, a pump or other fluid driving device (not illustrated) is located up or downstream of the evaporator 37, to force flow to the return part 16AR of the first circuit portion 16A. The water and oxygen produced by Reaction 2 may be collected as by-products by any convenient means. Preferably, a third separator 34C, which may for example comprise an iodine condenser and a water condenser or other suitable separating device(s)/apparatus, is provided in the third circuit portion 16C for separating the iodine and any water that may be present from the hydrogen produced by Reaction 3 in reaction zone RZ3. The reactor 12 is configured to deliver the separated iodine to the return part 16AR of the first circuit portion 16A that delivers the iodine to the reservoir 24B, the fluid flow optionally being driven by a pump or other fluid driving device (not shown). Preferably, the reactor 12 includes a mixer 38 for mixing the separated iodine with water (in particular the water produced by Reaction 3) such that the reactor delivers a mixture of iodine and water to the reservoir 24B. The hydrogen and any water produced by Reaction 3 may be collected by any convenient means. Any condenser(s) provided in the reactor 12 may optionally configured to serve as a heat exchanger, e.g. such that relatively cold process fluid exiting any one or more of the reservoirs 24A to 24D may be used as cooling fluid within the condenser.

The system 10 includes a control system 14 for controlling and/or monitoring the operation of the system components, including, as required, the reaction zones 18, control zones 28, valves 15, fluid drivers 20, furnaces 22 and separators 34, evaporator 37, mixer 38 and any other controllable device (e.g. fluid injectors, sensors and so on). The control system 14 typically comprises a master controller 52 which is typically implemented by one or more suitably programmed or configured hardware, firmware and/or software controllers, e.g. comprising one or more suitably programmed or configured microprocessor, microcontroller or other processor, for example an IC processor such as an ASIC, DSP or FPGA (not illustrated).

In preferred embodiments the control system 14 communicates control information to other components of the system 10, for example the control zones 28, valves 15, fluid drivers 20 and/or furnaces 22 in order to implement Reactions 1, 2 and 3. Process settings may be received via a process settings interface unit 51. The process settings may specify environmental conditions, for example in relation to temperature(s), flow rate(s), and/or pressure(s), and/or reactant levels (and/or concentrations) for the reaction zones 18. The control system 14 may also receive feedback information from other components of the system 10, for example the control zones 28, sensors, measurement devices, valves 15, fluid drivers 20 and/or furnaces 22, in response to which the control system 14 may issue control information to one or more relevant system components. To this end the control system 14 may perform analysis of the measurements or other information provided by the control zones 28. This analysis may be carried out automatically in real time by the control system 14. Alternatively, or in addition, analysis of the system measurements and performance may be made by an operator in real time or offline. The operator may make adjustments to the operation of the system 10 by providing control instructions via interface unit 51.

A safety controller 56 may be provided, which may receive alarm signals from one or more alarm sensors (not shown), e.g. gas sensors or leak detectors or emergency stops that may be included in the system 10, and provide alarm information to the master controller 52 based on the alarm signals received from the alarm sensors.

In preferred embodiments, the control system 14, and more particularly the master controller 52 is configured to implement system modelling logic, e.g. by supporting mathematical modelling software or firmware 60, for enabling the control system 14 to mathematically model the behaviour of the system 10, and in particular of the reactor 12, depending on the process settings and/or on feedback signals received from one or more system components during operation of the system 10.

Optionally, the control system 14 is configured to implement Model Predictive Control (MPC). Using MPC, the control system 14 causes the control action of the control zones 28 to be adjusted before a corresponding deviation from a relevant process set point actually occurs. This predictive ability, when combined with traditional feedback operation, enables the control system 14 to make adjustments that are smoother and closer to the optimal control action values than would otherwise be obtained. A control model for the system 10 can be written in Matlab, Simulink, or Labview by way of example and executed by the master controller 52. Advantageously, MPC can handle MIMO (Multiple Inputs, Multiple Outputs) systems.

The control system 14 may include an artificial intelligence (AI) based model controller 53 configured to optimize operation of the system 10 in real time in order to making best use of available energy, reactant levels and so on.

Advantageously, one or more parts of the reactor 12 may be configured in a modular manner to facilitate modular construction and transportation of the reactor 12 (or any part thereof), and/or to facilitate modular scaling of the reactor 12 or any part thereof. For example, each reaction zone 18 may be provided in a respective reactor module, which may be referred to as a sub-reactor. Advantageously, each reactor module is configured to support modular scaling of the respective reaction zone 18. For any given reaction zone 18, one or more instance of the respective type of reactor module may be provided (and modularly interconnected as required) in order to perform the respective reaction(s). The selected number of instances of reactor module that are used may depend on one or more desired operating parameter (e.g. any one or more of: energy usage, available energy, reactant usage, reactant availability, reaction product production rate, and so on) of the relevant application. As a result, the reactor 12, or any modular part thereof, may be scaled as suits the application. In preferred embodiments therefore, the reactor 12 comprises one or more chemical sub-reactors built in modules for easier fabrication/manufacture and transport. Furthermore, the reactor output may be sized, or scaled, based on the number of modules provided for each reaction, rather than solely through the size of individual reactors. This adds the benefit of extended turndown ratio for the reactor. Additionally, ancillary equipment (e.g. valve(s), pump(s) and/or heater(s)) and/or pre- and post-processing steps (e.g. fractional distillation) can be included in the modules as required.

The size of the reactor 12, in particular in terms of its power consumption, may vary to suit the application. Advantageously, sizing or scaling of the reactor 12 is supported by the preferred modularity of the reactor 12, or at least part(s) thereof. For example reactors embodying the invention may be designed with power consumption ranges of up to 200 KW, up to 500 KW, up to 1 MW, up to 2 MW, up to 5 MW or up to 10 MW, or up to 20 MW as required.

The preferred embodiment is now described in more detail. The H2O & I reservoir 24A and the SO2 reservoir 24B each comprises a suitable vessel or conduit, e.g. pressure vessel, for storing the respective reactant(s). Preferably, the SO2 is stored in gaseous form while the water and iodine are stored as a liquid mixture (typically with the iodine suspended in the water). Typically, the iodine is solid at the storage temperatures typically used. The ratio of I2 to H2O is preferably 1:1, with this preferably being managed by addition of H2O to the reservoir from an external source. The reservoirs 24A, 24B include at least one inlet for receiving the relevant reactant(s) from the recirculating, or return, part 16AR of the circuit portion 16A, and typically also from an external source of the relevant reactant(s). Water, iodine and/or sulphur dioxide can be received from external sources as required.

Each of the reservoirs 24A, 24B may each comprise any one or more of the following components as required and as applicable: a heating device; a pump or other fluid driving device; a mixing device; pressure measurement device(s); temperature measurement device(s); isolation valve(s); pressure relief valve(s); level measurement device(s), each of which may be controlled by the control system 14 and/or provide information to the control system 14, e.g. to ensure that the respective reactants are stored in the desired conditions, and/or to control the flow of the reactants into and/or out of the reservoir 24A, 24B. Typically, indications of fluid level, pressure and/or temperature are provided to the control system 14 by the reservoirs 24A, 24B. The reservoirs 24A, 24B store the reactants that are required for implementing Reaction 1 in reaction zone 1. Advantageously, the reservoirs 24A, 24B provide a buffer to allow variable process rates in the reaction zones and/or elsewhere in the reactor to be accommodated.

A first control zone CZ1 is provided downstream of the reservoirs 24A, 24B and is configured to control the flow of the respective reactants into reaction zone RZ1 (which may be referred to as a Bunsen reactor). The control zone CZ1 preferably includes means for generating fluid pressure to drive fluid through the reactor 12. For example, the compressor 20A may be arranged to drive the gas reactant (SO2) from reservoir 24A to reaction zone RZ1, while pump 20B may be arranged to drive the liquid reactants (H2O and I) from reservoir 24B to reaction zone RZ1. Valves 15 may be provided for controlling the flow of the relevant reactants from the reservoirs 24A, 24B to control zone CZ1. The control zone CZ1 may send information to the control system 14 indicating flow rate, pressure and/or temperature as required. The control zone CZ1 may receive control signals from the control system 14 for controlling pump or compressor operating speed(s) and/or operation of the valves 15 as required. Control zone CZ1 may also comprise any one or more of the following components: flow control and/or pressure regulating valve(s) with remote actuator(s) and/or mass flow controller(s) or other fluid injector(s); flow measurement device(s); pressure measurement device(s); temperature measurement device(s), each of which may be controlled by the control system 14 and/or provide information to the control system 14 as required.

The first reaction zone RZ1 is located downstream of control zone CZ1, and may be said to comprise a second control zone CZ2. Reaction zone RZ1 is configured to heat and mix the reactants to facilitate the Bunsen reaction (Reaction 1), which in preferred embodiments is a liquid phase reaction. RZ1 comprises a vessel or conduit, typically a pressure vessel, in which Reaction 1 is implemented. RZ1 preferably includes at least one heating device. RZ1 optionally includes an agitating device and/or a mixing device. RZ1 typically includes one or more pressure measurement device and/or one or more temperature measurement device. These devices may be controlled by the control system 14 and/or provide information to the control system 14 as required. In use, in reaction zone RZ1, the reactants mixed in the vessel are heated to the desired temperature for Reaction 1 (typically 120° C.). For example, the liquid reactants may be heated in the vessel with SO2 bubbled into the vessel. The Bunsen reaction is an exothermic reaction that is self-sustaining provided the SO2 is sufficiently heated prior to delivery. Reaction zone RZ1 receives control signals from the control system 14 for controlling the reaction temperature and/or reactant temperature as required (via the heating device(s)). Reaction zone RZ1 sends temperature and/or pressure measurement signals to the control system 14 as required. When Reaction 1 is complete, the reaction products (hydrogen iodide and sulphuric acid) are delivered to the first separator 34A, typically via a valve 15 which may be controlled by the control system 14.

The first separator 34A is located downstream of the reaction zone RZ1 and is configured to receive the reaction products form the reaction zone RZ1 and to separate them. The hydrogen iodide and sulphuric acid are typically produced in liquid form and may be separated using any conventional liquid separating means. In preferred embodiments the first separator 34A comprises a gravimetric separator although any other suitable conventional separating apparatus may be used, e.g. a distillation apparatus. The first separator 34A may comprise a vessel, e.g. a pressure vessel, and separation means, e.g. a gravimetric separation apparatus. The first separator 34A may also comprise any one or more of: flow control and/or isolation valve(s); temperature measurement device(s); pressure measurement device(s), each of which may be controlled by the control system 14 and/or provide information to the control system 14 as required. The preferred separator 34A is configured to allow the reaction products from RZ1 to settle and to separate them due to their different densities. The separator 34A may send signals to the control system 14 indicating the ratio of the reactants/unreacted water. The ratio of reactant products may be used as an indication of the performance of reaction zone RZ1. If there is an imbalance, or excess reactants remaining, then this indicates that the implementation of Reaction 1 may require modification. The ratio and/or level of each reactant can also facilitate flow of reactants from the separator to reservoirs 24A and 24B.

Advantageously, the separator 34A serves as means for transferring the reaction products from reaction zone RZ1 to separate buffer reservoirs, i.e. reservoirs 24C, 24D in the illustrated example. The reaction products may be delivered separately to the respective reservoir 24C, 24D from the separator 24A, typically via a respective valve which may be controlled by the control system 14. Optionally, one or more pump or other fluid driving device (not shown) may be provided to assist transferring the reaction products from reaction zone RZ1 to reservoirs 24C, 24D.

The HI reservoir 24C and the H2SO4 reservoir 24D each comprises a suitable vessel, e.g. pressure vessel, for storing the respective reaction product(s), which are typically stored in liquid form. The reservoirs 24C, 24D include at least one inlet for receiving the relevant reaction product from the separator 24A. Each of the reservoirs 24C, 24D may each comprise any one or more of the following components as required and as applicable: a heating device; a pump or other fluid driving device; pressure measurement device(s); temperature measurement device(s); isolation valve(s); flow control valve(s); pressure relief valve(s); level measurement device(s), each of which may be controlled by the control system 14 and/or provide information to the control system 14, e.g. to ensure that the respective reaction products are stored in the desired conditions and/or to control the flow of the reaction products into and/or out of the reservoir 24C, 24D. Typically, indications fluid level, pressure, flow rate and/or temperature are provided to the control system 14 by the reservoirs 24C, 24D. Typically, the reservoirs 24C, 24D receives control signals from the control system 14 to regulate internal pressure, control valves and pump(s), as applicable, for controlling the flow of reactants to reaction zones RZ2 and RZ3.

The reservoirs 24C, 24D may be accumulator type reservoirs wherein an inert gas may be used to pressurise the reservoir. Accumulator type operation allows Reactions 2 and 3 to progress without requiring a constant supply of reactants from reaction zone RZ1.

The reservoir 24C stores the reactant that is required for implementing Reaction 3 in reaction zone 3. The reservoir 24D stores the reactant that is required for implementing Reaction 2 in reaction zone 2. Advantageously, the reservoirs 24C, 24D provide a buffer to allow variable process rates in the reaction zones and/or elsewhere in the reactor to be accommodated. The reservoirs advantageously act as energy stores for absorbing excess electrical energy, and as boilers to vaporise the liquids and drive flow of the reactants to the next stage of the process.

Reservoir 24C has an outlet connected to the third circuit portion 16C for delivering hydrogen iodide to reaction zone RZ3. Reservoir 24D has an outlet connected to the second circuit portion 16B for delivering hydrogen iodide to reaction zone RZ2.

Reaction zone RZ2 comprises a reaction vessel or conduit in which Reaction 2 takes place. Reaction 2 may be said to comprise the thermal decomposition or disassociation of sulphuric acid. In preferred embodiments, the vessel supports phase change of liquid sulphuric acid to water vapour and gaseous SO2/SO3 and O2. Optionally, a suitable catalyst may be provided in the vessel to reduce activation energy of reduction of SO3 to SO2. Reaction zone RZ2 typically comprises any one or more of: temperature measurement device(s); pressure measurement devices(s); flow measurement device(s), each of which may be controlled by the control system 14 and/or provide information to the control system 14 as required.

Furnace 22A is operable to heat the sulphuric acid to sufficient temperature (typically >340 C) to initiate dissociation to SO3, H2O and O2. The furnace 22A may also be used to heat vapour phase reaction products from the dissociation (typically >850 C) to enable conversion of SO3 to SO2. In preferred embodiments, the furnace 22A is part of reaction zone RZ2, and may be said to comprise a control zone CZ3. The optional catalyst may be used to reduce the peak temperature required. Operation of the furnace 22A is controlled by the control system 14, optionally depending on temperature measurements received by the control system 14 from the reaction zone RZ2.

In preferred embodiments, the furnace 22A comprises a high thermal inertia electric furnace. More generally an electrically powered furnace is preferred. Alternatively, a combustion based heater or other heating device(s) may be used to perform the required heating for RZ2.

The reaction products (water vapour, SO2 and O2) from reaction zone RZ2 are transferred from the reaction vessel to separator 34B for separation. In preferred embodiments, these reaction products (which are relatively hot) are directed through heat exchanger 26A, and the sulphuric acid reactant (which is relatively cool) provided from reservoir 24D is also passed through heat exchanger 26B before being delivered to reaction zone RZ2. The relatively hot reaction products (water vapour, SO2 and O2) from reaction zone RZ2 are cooled by the heat exchanger 26 while the sulphuric acid reactant is heated, thereby improving energy efficiency of the reactor 12. Increasing the temperature of the reactant prior to entry to reaction zone RZ2 in this way makes use of otherwise wasted energy, and so reduces the energy input requirements of reaction zone RZ2. Moreover, the heat exchanger 26A may initiate a phase change of the sulphuric acid (from liquid to gas) and/or initiate Reaction 2, which also reduces the energy input requirements of reaction zone RZ2. The heat exchanger 26A may comprise any suitable configuration of gas-gas or gas-liquid heat exchange device(s). Heat exchanger 26A typically comprises any one or more of: temperature measurement device(s); pressure measurement devices(s), each of which may be controlled by the control system 14 and/or provide information to the control system 14 as required.

The separator 34B is located downstream of reaction zone RZ2 (and heat exchanger 26A when present) and is configured to receive the reaction products form the reaction zone RZ2 and to separate them, or at least to separate the SO2. The water vapour, SO2 and O2 are typically received in gaseous or vapour form and may be separated using any conventional gas/vapour separating means. In preferred embodiments the second separator 34B comprises one or more condenser. In the illustrated example, the separator 34B comprises a water condenser for condensing the water vapour. The condensed water may then be stored or drained as desired. The separator 34B may comprise a sulphur dioxide condenser for condensing the SO2. Alternative means for separating the SO2 and O2 may be used. Optionally, the SO2 and O2 are not separated (and both may be returned to the reservoir(s)). Preferably, the condensed SO2 is provided to an evaporator to return the SO2 to a gaseous or vapour state for storage. The remaining oxygen may be vented or stored as desired. Coolant for the condenser(s) may be provided from an external source, or from an internal source, e.g. from one or more of reservoirs 24B, 24C, 24D.

Separator 34B, which may also be said to comprise control zone CZ4, typically comprises any one or more of: temperature measurement device(s); pressure measurement devices(s); flow measurement device(s); level measurement device(s); fluid driving device(s); flow control valve(s), each of which may be controlled by the control system 14 and/or provide information to the control system 14 as required. In use, the separator 34B cools and condenses the reaction products after exiting the heat exchanger. Optionally, cold reaction products may be used as the condenser cooling fluid. Alternatively or in addition, coolant can be supplied from external source, particularly for condensing SO2 where there is a low condensation temperature. The separator 34B may send signals to the control system 14 indicating temperature, pressure, and/or condenser fluid level(s), and may receive control signals from the control system 14 to regulate coolant flow and/or temperature, and to regulate fluid flow out of condensers. Valves may be provided as required for controlling fluid flow from the condensers. Separator 34B has an outlet for delivering the separated SO2 to the return part 16AR of the first circuit portion 16A for recirculating the SO2 to the reservoir 24A. In preferred embodiments, the separated SO2 is outlet from the evaporator such that it is returned to the reservoir 24A in gaseous or vapour form for storage.

Reaction zone RZ3 comprises a reaction vessel or conduit in which Reaction 3 takes place. Reaction 3 may be said to comprise the thermal decomposition or disassociation of hydrogen iodide. In preferred embodiments, the vessel supports phase change of liquid hydrogen iodide to vapour. Reaction zone RZ3 typically comprises any one or more of: temperature measurement device(s); pressure measurement devices(s); flow measurement device(s), each of which may be controlled by the control system 14 and/or provide information to the control system 14 as required.

Furnace 22B is operable to heat the hydrogen iodide to sufficient temperature (typically >130 C) to cause phase change to vapour. The furnace 22B is further operated to heat the vapour phase aqueous HI to cause dissociation of HI to H2 and I2 (typically >450 C). Water vapour is typically present as the HI is usually not 100% concentrated. In preferred embodiments, the furnace 22B is part of reaction zone RZ3, and may be said to comprise a control zone CZ5. Operation of the furnace 22B is controlled by the control system 14, optionally depending on temperature measurements received by the control system 14 from the reaction zone RZ3.

In preferred embodiments, the furnace 22B comprises a high thermal inertia electric furnace. More generally an electrically powered furnace is preferred. Alternatively, a combustion based heater or other heating device(s) may be used to perform the required heating for RZ3.

The reaction products (water vapour, iodine and H2) from reaction zone RZ3 are transferred from the reaction vessel to separator 34C for separation. In preferred embodiments, these reaction products (which are relatively hot) are directed through heat exchanger 26B, and the hydrogen iodide reactant (which is relatively cool) provided from reservoir 24C is also passed through heat exchanger 26B before being delivered to reaction zone RZ3. The relatively hot reaction products from reaction zone RZ3 are cooled by the heat exchanger 26B while the hydrogen iodide reactant is heated, thereby improving energy efficiency of the reactor 12. Increasing the temperature of the reactant prior to entry to reaction zone RZ3 in this way makes use of otherwise wasted energy, and so reduces the energy input requirements of reaction zone RZ3. Moreover, the heat exchanger 26B may initiate a phase change of the hydrogen iodide (from liquid to gas) and/or initiate Reaction 3, which also reduces the energy input requirements of reaction zone RZ3. The heat exchanger 26B may comprise any suitable configuration of gas-gas, liquid-liquid, gas-liquid heat exchange device(s). Heat exchanger 26B typically comprises any one or more of: temperature measurement device(s); pressure measurement devices(s), each of which may be controlled by the control system 14 and/or provide information to the control system 14 as required.

The separator 34B is located downstream of reaction zone RZ3 (and heat exchanger 26B when present) and is configured to receive the reaction products form the reaction zone RZ3 and to separate them. The water vapour, iodine and H2 are typically received in gaseous or vapour form and may be separated using any conventional gas/vapour separating means. In preferred embodiments the second separator 34C comprises one or more condenser. In the illustrated example, the separator 34B comprises an iodine condenser for condensing the iodine. The separator 34C also comprises a water condenser for condensing the water vapour. At least some of the condensed water may then be stored, pumped and/or drained as desired. Coolant for the condenser(s) may be provided from an external source, or from an internal source, e.g. from one or more of reservoirs 24B, 24C, 24D. The condensed iodine is returned, or recirculated, to the reservoir 24B by the return part 16AR of the first circuit portion 16A. Preferably, the iodine is mixed with water before being returned to the reservoir 24B. This may be achieved by directing the condensed iodine and at least some of the condensed water to mixer 38. Mixer 38 may have an outlet connected to the return part 16AR for returning the water and iodine mixture to the reservoir 24B. The separated H2 gas may be vented and/or stored as desired.

Separator 34C, which may also be said to comprise control zone CZ6, typically comprises any one or more of: temperature measurement device(s); pressure measurement devices(s); flow measurement device(s); level measurement device(s); fluid driving device(s); flow control valve(s), each of which may be controlled by the control system 14 and/or provide information to the control system 14 as required. In use, the separator 34C cools and condenses the reaction products after exiting the heat exchanger. Optionally, cold reaction products may be used as the condenser cooling fluid. Alternatively or in addition, coolant can be supplied from external source. The separator 34C may send signals to the control system 14 indicating temperature, pressure, and/or condenser fluid level(s), and may receive control signals from the control system 14 to regulate coolant flow and/or temperature, and to regulate fluid flow out of condensers. Valves may be provided as required for controlling fluid flow from the condensers. Separator 34C has an outlet for delivering the separated iodine to the return part 16AR of the first circuit portion 16A for recirculating the iodine to the reservoir 24B. In preferred embodiments, the separated iodine is outlet from the mixer 38 such that it is returned to the reservoir 24B mixed with water. Typically, the iodine quickly solidifies from liquid phase at reasonably high temperatures (>100 C), maintaining iodine in liquid form can be energy intensive, hence the preference for a carrier (in particular water). In alternative embodiments, the reactor 12 may be configured to maintain the iodine in liquid form in which case it does not need to be mixed with water (or other carrier), and may optionally be stored in a separate reservoir to the water.

It is noted that, in preferred embodiments, each of the second and third circuit portions 16B, 16C utilises its own heat exchanger 26A, 26B to allow greater flexibility for non-uniform reaction rates where variable power supply is used. The 3 reactions run on a single recirculating reactor, but can operate somewhat independently when required.

The invention is not limited to the embodiment(s) described herein but can be amended or modified without departing from the scope of the present invention.

1. A system for producing hydrogen from water by a thermochemical cycle comprising at least one reaction, the system comprising a reactor configured to implement the thermochemical cycle, the reactor comprising:
at least one fluid circuit;
means for driving fluid around said at least one fluid circuit;
a respective reaction zone for implementing at least one reaction, each reaction zone being connected to said at least one fluid circuit,
wherein said reactor is configured to at least one of:
direct at least one reaction product from at least one of said at least one reaction to the respective reaction zone of at least one other of said at least one reaction to provide at least one reactant for said at least one other of said at least one reaction;
to recirculate fluid around said at least one fluid circuit whereby at least one reaction product from at least one of said at least one reaction is recirculated to the respective reaction zone of at least one of said at least one reaction to provide at least one reactant for said at least one of the at least one reaction.

2. The system of claim 1, wherein said reactor is configured to recirculate at least one reaction product from at least one of said at least one reaction to the respective reaction zone of at least one other of said at least one reaction to provide at least one reactant for at least one of the respective at least one reaction.

3. The system of claim 1, wherein said at least one reaction comprises a first reaction and at least one other reaction, which is implemented in a reaction zone downstream of the reaction zone of the first reaction, said reactor being configured to recirculate at least one reaction product from at least one of said at least one other reaction to the respective reaction zone of said first reaction to provide at least one reactant for said first reaction.

4. The system of claim 1, wherein said at least one reaction comprises a first reaction and at least one other reaction, which is implemented in a reaction zone downstream of the reaction zone of the first reaction, said reactor being configured to direct at least one reaction product from said first reaction to the respective reaction zone of at least one of said at least one other reaction to provide at least one reactant for said at least one of said at least one other reaction.

5. The system of claim 1, further comprising any one or more of:
at least one reservoir for storing at least one reactant, and wherein said reactor is configured to recirculate at least one reaction product from at least one of said at least one reaction to said at least one reservoir for delivery to the respective reaction zone;
at least one heat exchanger configured to perform heat exchanging between fluid exiting at least one reaction zone and fluid being delivered to at least one reaction zone;
a control system configured to control at least one parameter of fluid in said at least one fluid circuit in order to implement said at least one reaction in the respective reaction zone, wherein said at least one parameter may comprise any one or more of: fluid composition; fluid temperature; fluid flow rate; fluid pressure; fluid level; and means for heating fluid in said reactor.

6-8. (canceled)

9. The system of claim 1, wherein said thermochemical cycle is a Sulphur-iodine cycle, and wherein the reactor comprises:
a first reaction zone for implementing a first reaction in which first reactants water, sulphur dioxide and iodine react to form first reaction products sulphuric acid and hydrogen iodide;
a second reaction zone for implementing a second reaction involving decomposition of second reactant sulphuric acid into second reaction products sulphur dioxide, oxygen and water;
a third reaction zone for implementing a third reaction involving decomposition of third reactant hydrogen iodide into third reaction products iodine and hydrogen; and
at least one reservoir for storing said first reactants,
wherein said reaction zones and said at least one reservoir when present are inter-connected by said at least one fluid circuit,
and wherein said at least one reservoir (when present) and said first reaction zone are located in a first portion of said fluid circuit, said first circuit portion branching into a second circuit portion and a third circuit portion downstream of said first reaction zone, said second reaction zone being located in said second circuit portion and said third reaction zone being located in said third circuit portion, and wherein said second and third circuit portions are connected to said first circuit portion downstream of said second reaction zone and said third reaction zone respectively,
and wherein the reactor further includes means for separating said first reaction products, said reactor being configured to direct the separated sulphuric acid to said second reaction zone and the separated hydrogen iodide to said third reaction zone,
and wherein said reactor is configured to direct the second reaction product Sulphur dioxide to said first reaction zone, preferably-via said at least one reservoir when present, and to direct the third reaction product iodine to said first reaction zone, via at least one reservoir when present, and wherein, the system further includes means for separating said second reaction products, said reactor being configured to direct the separated sulphur dioxide to said first reaction zone, via said at least one reservoir when present; and/or means for separating said third reaction products, said reactor being configured to direct the separated iodine to said first reaction zone, via said at least one reservoir when present.

10. The system of claim 9, wherein said at least one reservoir is located upstream of said first reaction zone and comprises a first reservoir for storing water and iodine, a suspension of iodine in water, and a second reservoir for storing sulphur dioxide, in gaseous form.

11. The system of claim 9, wherein said driving means comprises means for delivering said first reactants to said first reaction zone from said at least one reservoir under pressure, and wherein said driving means optionally comprises a compressor for driving said Sulphur dioxide from said at least one reservoir, and a pump for driving said water and iodine from said at least one reservoir.

12. The system of claim 9, wherein said first circuit portion is configured to deliver said first reactants to said first reaction zone separately, and may include at least one valve operable to control the flow of said first reactants to said first reaction zone.

13. The system of claim 9, wherein said first reaction zone comprises a vessel, conduit or chamber and is configured to heat and/or mix said first reactants to implement said first reaction, said first reaction zone including or being associated with at least one valve operable to control the flow of said first reaction products to said means for separating said second reaction products, and/or wherein said second reaction zone comprises a vessel, conduit or chamber and is configured to heat said second reactant in order to implement said second reaction, said second reaction zone including a catalyst to facilitate said second reaction, and/or wherein said third reaction zone comprises a vessel, conduit or chamber and is configured to heat said third reactant in order to implement said third reaction.

14. The system of claim 9, wherein said heating means comprises at least one heating device for heating said first reactants to a desired temperature for said first reaction, said at least one heating device being included in said first reaction zone, and/or wherein said heating means comprises at least one heating device for heating said second reactant to a desired temperature for said second reaction, and wherein said at least one heating device is optionally included in said second reaction zone or otherwise associated with said second reaction zone, and/or wherein said heating means comprises at least one heating device for heating said third reactant to a desired temperature for said third reaction, and wherein said at least one heating device is optionally included in said third reaction zone or otherwise associated with said third reaction zone, and wherein the heating means for at least one of said second reaction zone and the heating means for the third reaction zone comprises at least one of: a furnace, an electric furnace, a high thermal inertia electric furnace, or an electrically powered heating apparatus.

15. The system of claim 9, wherein said means for separating said first reaction products comprises at least one of: a gravimetric separator or a liquid separating apparatus.

16. The system of claim 9, wherein said reactor further includes at least one reservoir for storing the separated first reaction products, and at least one valve operable to control the flow of the separated first reaction products to said at least one reservoir, and wherein, said reactor is configured to direct the separated sulphuric acid to said second circuit portion from said at least one reservoir, and to direct the separated hydrogen iodide to said third circuit portion from said at least one reservoir, and includes at least one valve operable to control the flow of the separated first reaction products from said at least one reservoir to said first and second circuit portions, and/or wherein said at least one reservoir comprises a third reservoir for storing said sulphuric acid, in liquid form, and a fourth reservoir for storing said hydrogen iodide, in liquid form.

17. The system of claim 9, wherein said means for separating said second reaction products comprises at least one condenser, or at least one other gas or vapour separator, said separating means comprising a water condenser and/or a Sulphur dioxide condenser, optionally a Sulphur dioxide condenser for separating Sulphur dioxide from said second reactant products in liquid form, and an evaporator for converting said liquid Sulphur dioxide to a vapour or gaseous state, and/or wherein said means for separating said third reaction products comprises at least one condenser, or at least one other gas or vapour separator, said separating means comprising a water condenser and/or an iodine condenser.

18. The system of claim 9, wherein said first circuit portion includes a return part configured to deliver fluid to said at least one reservoir for storing said first reactants, or otherwise to deliver fluid directly or indirectly to said first reaction zone, and wherein said second circuit portion is configured to deliver the separated sulphur dioxide to said return part for delivery to said at least one reservoir for storing said first reactants or otherwise directly or indirectly to said first reaction zone, wherein said separated Sulphur dioxide is returned to said at least one reservoir or said first reaction zone in vapour or gaseous form, and/or wherein said third circuit portion is configured to deliver the separated iodine to said return part for delivery to said at least one reservoir for storing said first reactants or otherwise directly or indirectly to said first reaction zone, wherein said separated iodine is returned to said at least one reservoir or said first reaction zone mixed with water.

19. The system of claim 9, wherein said means for separating said second reaction products and/or said means for separating said third reaction products comprises at least one valve operable to control the flow of said separated second reaction products.

20. The system of claim 9, wherein said reactor includes a mixer for mixing said separated iodine with water, said reactor being configured to direct the separated iodine mixed with water to said at least one reservoir, or otherwise directly or indirectly to said first reaction zone, and wherein said mixer is arranged to mix said separated iodine with water separated from said third reaction products.

21. The system of claim 9, wherein said reactor includes at least one heat exchanger arranged to perform heat exchanging between said second reactant and at least one of said second reaction products and said third reaction products, whereby said second reactant is heated by said second reaction products and/or third reaction products, and said second and/or third reaction products are cooled by said second reactant, wherein said at least one heat exchanger is provided in said second circuit portion, and is arranged to receive said second reactant and said second reaction products, and to perform heat exchanging whereby said second reactant is heated by said second reaction products, and said second reaction products are cooled by said second reactant, and/or wherein said reactor includes at least one heat exchanger arranged to perform heat exchanging between said third reactant and at least one of said second reaction products and said third reaction products, whereby said third reactant is heated by said second reaction products and/or third reaction products, and said second and/or third reaction products are cooled by said third reactant, wherein at least one heat exchanger is provided in said third circuit portion, and is arranged to receive said third reactant and said third reaction products, and to perform heat exchanging whereby said third reactant is heated by said third reaction products, and said third reaction products are cooled by said third reactant.

22. The system of claim 1, wherein a plurality of control zones are included in said fluid circuit at a respective different location, each control zone including at least one device for controlling at least one parameter of said fluid in accordance with control information and/or at least one parameter measurement device, the system further including a control system for controlling operation of the reactor, the control system being in communication with said control zones to provide each control zone with said control information and/or to receive parameter measurement information from the control zone, and wherein said at least one parameter comprises a respective parameter indicating any one or more of: fluid composition; fluid temperature; fluid flow rate; fluid pressure; fluid level, and wherein, said control system is configured to calculate said control information by mathematically modelling said reactor using Model Predictive Control (MPC), and/or wherein said control system is configured to determine said control information using a mathematical model of the reactor, and wherein said mathematical model comprises a neural network model whereby said control system is configured to calculate said control information using an artificial neural network.

23. (canceled)

24. The system of claim 9, wherein said means for separating said third reaction products comprises means for separating said hydrogen and means for venting, storing and/or collecting the separated hydrogen.

25. A method of producing hydrogen from water by a thermochemical cycle comprising at least one reaction, the method comprising:
implementing the, or each, reaction or a respective one or more of said at least one reaction, in a respective reaction zone of a reactor to produce at least one reaction product from at least one reactant,
wherein the, or each, reaction zone is connected to at least one fluid circuit of said reactor, and wherein the method further comprises:
directing at least one reaction product from at least one of said at least one reaction to the respective reaction zone of at least one other of said at least one reaction to provide at least one reactant for said at least one other of said at least one reaction; and/or
recirculating fluid around said at least one fluid circuit, said recirculating comprising recirculating at least one reaction product from at least one of said at least one reaction to the respective reaction zone of at least one of said at least one reaction to provide at least one reactant for said at least one of the at least one reaction.
